(19) United States
(12) Patent Application Publication
(10) Pub. No.: US 2013/0180407 A1
(43) Pub. Date: Jul. 18, 2013

(54) BREWING UNIT FOR BREWED BEVERAGE-MAKING MACHINES

(71) Applicant: Paolo COLLEONI, San Pellegrino (IT)

(72) Inventor: Paolo COLLEONI, San Pellegrino (IT)

(73) Assignee: N&W GLOBAL VENDING S.P.A., Valbrembo (IT)

(21) Appl. No.: 13/549,766

(22) Filed: Jul. 16, 2012

(30) Foreign Application Priority Data
Jul. 14, 2011 (IT) TO2011A 000619

(51) Int. Cl. A47J 31/44

(52) U.S. Cl. CPC A47J 31/4403
USPC 99/289 R

(57) ABSTRACT

A brewing unit for brewed beverage-making machines, wherein a brewing assembly, associated with a waste material bin beneath the brewing assembly, has a number of members including a brewing chamber for receiving brew material, a first unloading member movable along the brewing chamber to expel the waste material from the brewing chamber, and a second unloading member movable with respect to the brewing chamber to engage and unload the expelled waste material into the bin; at least one of the members being an oscillating member mounted to oscillate about an axis; and a levelling member being associated with the oscillating member to oscillate inside the bin.

### CROSS-REFERENCE TO RELATED APPLICATIONS

This application claims priority to Italian Application No. TO2011A000619 filed on 14 Jul. 2011, the contents of which are incorporated herein, in their entirety, by this reference.

### TECHNICAL FIELD

Embodiments of the present invention relates to a brewing unit for brewed, in particular coffee, beverage-making machines.

More specifically, embodiments of the present invention relate to a brewing unit of the type comprising a brewing assembly, and a bin located beneath the brewing assembly to catch the waste material expelled from the brewing assembly; the brewing assembly comprising a number of members, in turn comprising a brewing chamber for receiving brew material, first unloading means movable along the brewing chamber to expel the waste material from the brewing chamber, and second unloading means movable with respect to the brewing chamber to engage the expelled waste material and unload it into the bin; at least one of said members being mounted to perform an oscillating movement.

### BACKGROUND

A brewing assembly of this type is described in the Applicant's WO/2009/007804 published on 15 Jan. 1009, and EP 2241228 published on 20 Oct. 2010.

Though designed for use with the brewing assembly described in EP2241228, in which both the brewing chamber and the first unloading means are mounted to oscillate about an axis, it can also be used with any brewing assembly, in which the brewing chamber is fixed, but at least one oscillating member, e.g. an oscillating member forming part of the first or second unloading means, is provided.

Brewing units of the above type pose the problem of effectively distributing the waste material inside the bin, and more specifically of preventing the waste material dumped into the bin from forming a rapidly rising cone which soon reaches the brewing assembly overhead, with the result that only part of the volume of the bin is actually used.

### SUMMARY

It is an object of one or more embodiments of the present invention to provide a brewing unit of the above type, designed to provide a simple, relatively low-cost method of distributing the waste material inside the bin.

According to an embodiment of the present invention, there is provided a brewing unit. The brewing unit includes a brewing assembly associated with a waste material bin beneath the brewing assembly and having a number of members that include a brewing chamber for receiving brew material, a first unloading member movable along the brewing chamber to expel the waste material from the brewing chamber, and a second unloading member movable with respect to the brewing chamber to engage and unload the expelled waste material into the bin. At least one of the members is an oscillating member mounted configured to oscillate about an axis. A levelling member is associated with the oscillating member to oscillate inside the bin.

### BRIEF DESCRIPTION OF THE DRAWINGS

A non-limiting embodiment of the present invention will be described by way of example with reference to the accompanying drawings, in which:

FIG. 1 shows a partly hatched, partly sectioned view of a preferred embodiment of the brewing unit according to the present invention;

FIGS. 2 to 6 show a detail of FIG. 1 in respective operating positions;

FIG. 7 shows a larger-scale view in perspective of a detail in FIGS. 1 to 6.

### DETAILED DESCRIPTION

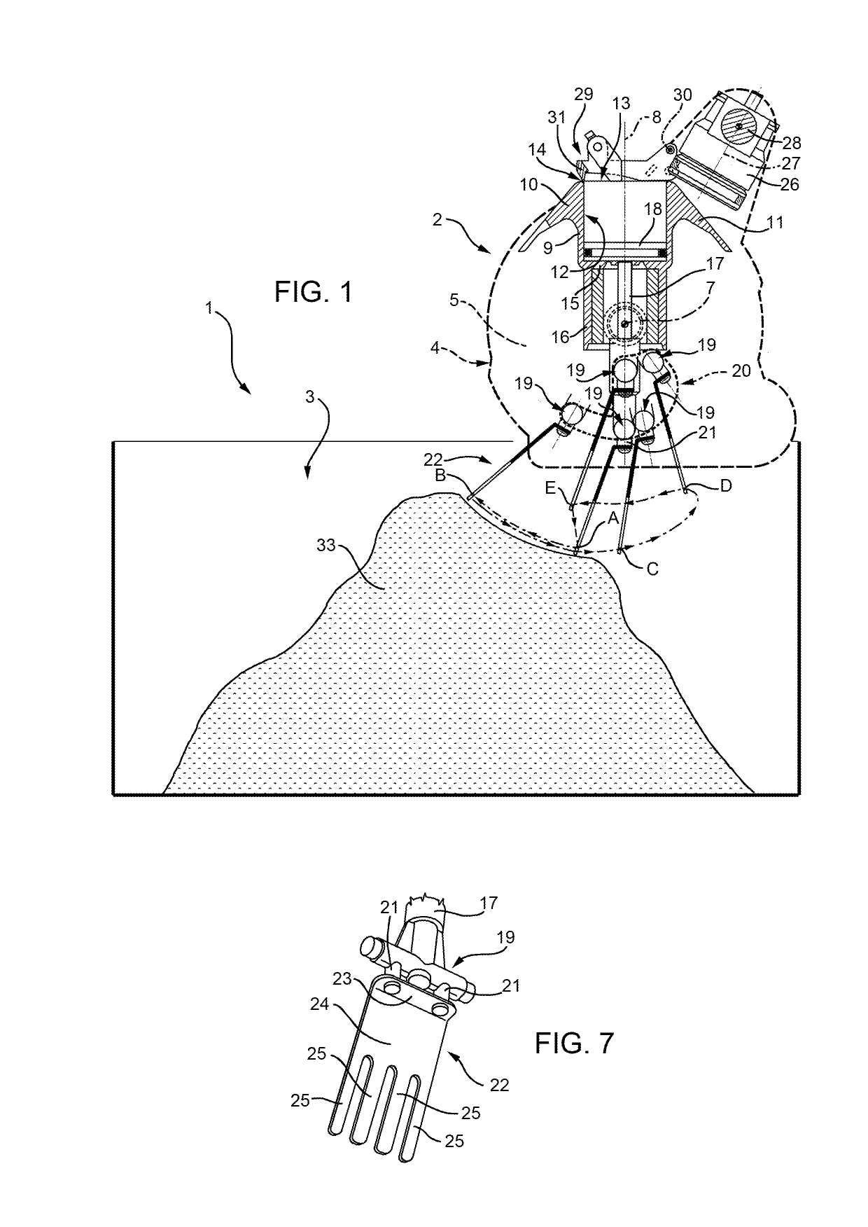

Number 1 in FIG. 1 indicates as a whole a brewing unit for brewed, in particular coffee, beverage-making machines (not shown).

Unit 1 comprises a known brewing assembly 2 for receiving brew material—in this case, ground coffee for producing espresso (ES) and/or fresh-brew (FB) coffee; and a cup-shaped, open-topped bin 3 located beneath brewing assembly 2 to catch the waste material—in this case, coffee grounds—expelled from brewing assembly 2.

Brewing assembly 2 is substantially identical to the one described in EP 2241228, to which the reader is referred for a detailed description.

Generally, brewing assembly 2 comprises a casing 4 defined by two integral vertical shoulders 5 (only one shown) spaced a given distance apart to define a space housing an elongated brewing body 6, which is fitted to shoulders 5 to oscillate, with respect to casing 4, about a horizontal axis 7 perpendicular to shoulders 5.

Brewing body 6 has a longitudinal axis 8 perpendicular to axis 7, and comprises a top portion defined by a cylindrical cup-shaped body 9 with a sloping front tab 10 and a sloping rear tab 11. Cup-shaped body 9 is coaxial with axis 8, internally defines a brewing chamber 12 communicating with the outside through a top loading-unloading opening 13 formed through a top surface 14, and is closed at the bottom by a bottom wall 15.

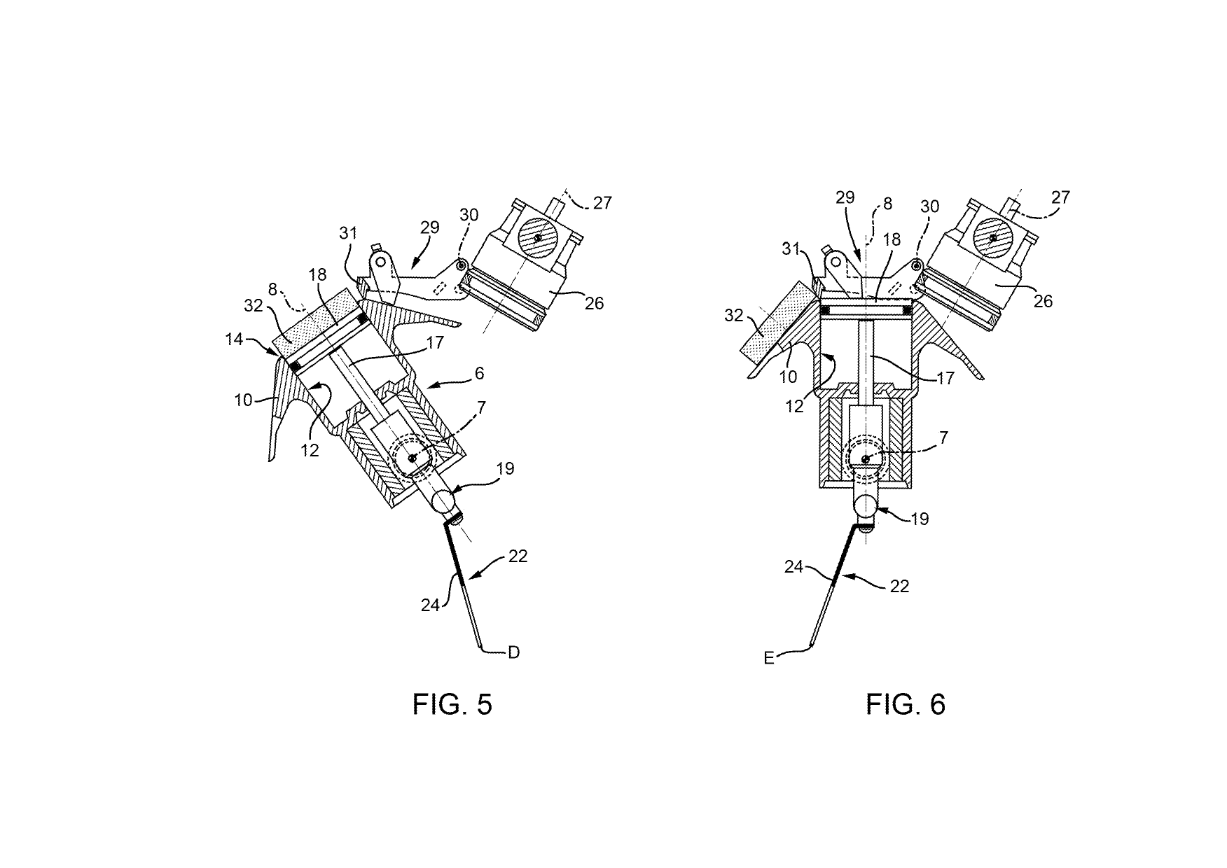

Brewing body 6 also comprises a bottom portion defined by a tubular body 16 coaxial with cup-shaped body 9 and extending downwards from bottom wall 15. The rod 17 of an ejector piston 18 is mounted to slide inside tubular body 16 and through an axial hole formed through bottom wall 15; piston 18 is defined by a plate mounted to slide axially inside brewing chamber 12; and the bottom end of rod 17, opposite the end connected to piston 18, is fitted with a T-shaped member 19 (FIG. 7), the bottom end of which has two diametrically opposite radial arms, each of which engages a respective system 20 of fixed and movable control cams connected to respective panel 5 and described in detail in EP 22412281. Piston 18 is normally maintained in a lowered rest position, contacting bottom wall 15 of cup-shaped body 9, by elastic means (not shown) fitted to rod 17 and compressed between bottom wall 15 and T-shaped member 19.

As shown more clearly in FIG. 7, each arm of T-shaped member 19 has a radial appendix 21, which projects downwards, parallel to rod 17 and axis 8, and supports, together with the other radial appendix 21, a levelling device 22 projecting beneath casing 4 and inside bin 3.

Levelling device 22 comprises a bent plate, in turn comprising a portion 23 crosswise to axis 8 and connected integrally to the free ends of appendixes 21; and a further portion, which extends from portion 23 to define a substantially rectangular paddle 24 bent downwards and frontwards with respect to, and forming an angle of 100-150° with, portion 23.

In the example shown, paddle 24 is toothed, with longitudinal end teeth 25.

The space between shoulders 5 is also fitted with a pressure piston 26 having a longitudinal axis 27, and two diametrically opposite radial appendixes 28 (only one shown), which are coaxial with each other and with an axis parallel to axis 7, and each engage, in transversely-sliding, angularly-fixed manner, a respective guide (not shown) fitted to respective panel 5.

Full details of piston 26 and its operating system are also provided in EP 2241228.

Piston 26 is movable along axis 27 between a lowered position, in which piston 26 slides in fluidtight manner along cup-shaped body 9 to close brewing chamber 12, and a raised position, in which piston 26 is fully extracted from and located a given height above brewing chamber 12.

The space between shoulders 5 is also fitted with a passive doctor device 29 for unloading into bin 3 the waste material expelled from brewing chamber 12 by piston 18.

Doctor device 29 is U-shaped, is hinged to shoulders 5, frontwards of piston 26, to oscillate about an axis 30 parallel to axis 7, and comprises an intermediate member defined by a doctor 31, which is parallel to axis 7, is located along the path travelled by top surface 14 of cup-shaped body 9 oscillating about axis 7, and is pushed by elastic means (not shown) to normally slide in contact with top surface 14 and tab 10.

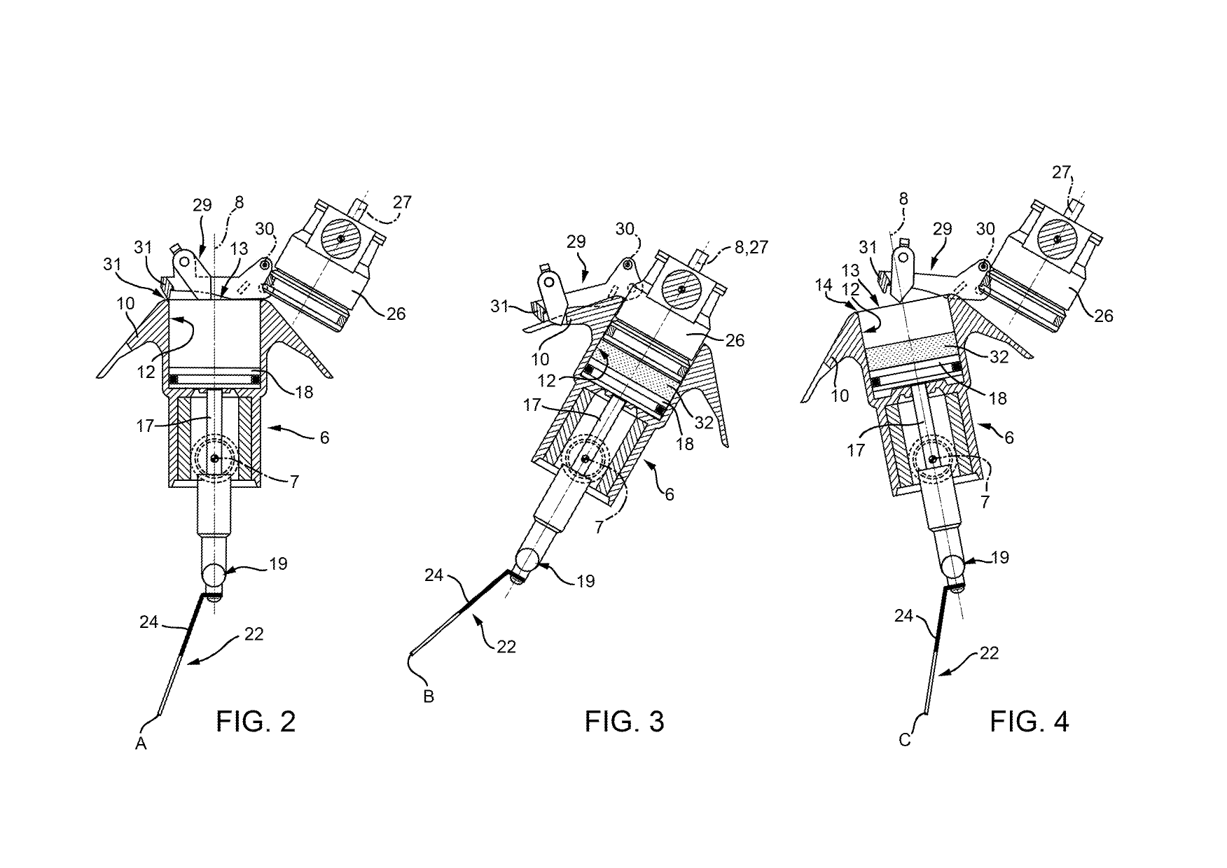

Operation of brewing unit 1 is described in detail in EP 2241228, so will only be described here briefly, with particular reference to the operation of levelling device 22 as a function of the successive positions assumed by brewing body 6 during each beverage, i.e. ES or FB, making cycle, and as of the FIGS. 1 and 2 loading position, in which axis 7 is substantially vertical, opening 13 of cup-shaped body 9 is located between axis 30 and doctor 31 and directly beneath a hopper (not shown) for loading the brew material, piston 18 is in the lowered rest position contacting bottom wall 15 of brewing chamber 12, piston 26 is in a raised rest position, and the free end of paddle 24 is in a position A (FIGS. 1 and 2) inside bin 3.

Once the brew material is loaded, brewing body 6 is rotated (clockwise in FIGS. 1 and 3) about axis 7 to move brewing chamber 12 into a brewing position, in which opening 13 of brewing chamber 12 is aligned with and positioned facing piston 26, which can then be lowered (FIG. 3) inside the brewing chamber to close it and make the beverage. When making the beverage, the free end of paddle 24 remains stationary in a position B (FIGS. 1 and 3) inside bin 3.

Once the beverage is brewed, piston 26 is extracted from the brewing chamber, and brewing body 6 is rotated in the opposite (anticlockwise) direction.

Over a first part (FIG. 4) of the anticlockwise rotation of brewing body 6, during which opening 13 moves beneath doctor 31, piston 18 remains in the lowered rest position, and the free end of paddle 24 moves along an arc of a circle coaxial with axis 7, to move through position A into a position C (FIGS. 1 and 4).

Over a second part of the anticlockwise rotation of brewing body 6, during which opening 13 moves past doctor 31 (FIG. 5), piston 18 moves into a fully extracted position, and the free end of paddle 24 moves into a position D (FIGS. 1 and 5).

As shown in FIG. 5, as it moves into the extracted position, piston 18 expels a cake 32 of waste material from brewing chamber 12 and into a position outwards of opening 13 of brewing chamber 12.

Once the cake is expelled, brewing body 6 is rotated again in the opposite (clockwise) direction.

As brewing body 6 rotates clockwise, piston 18 remains in the extracted position (FIG. 6); opening 13 moves back into the loading position, moving beneath doctor 31, so that cake 32 is engaged by doctor 31, is moved gradually onto tab 10, and eventually drops into bin 3 along a fall path extending substantially vertically downwards from the free end of tab 10; and the free end of paddle 24 moves from position D to a position E (FIGS. 1 and 6) along a substantially circular trajectory centred about axis 7 but smaller in radius than the arc B-A-C described above.

Finally, piston 18 is moved into the rest position, thus moving the free end of paddle 24 from position E to position A.

As shown in FIG. 1, as the above operating cycle is performed repeatedly by unit 1, cakes 32 drop into bin 3, and, accumulating at the bottom of bin 3, tend to form a substantially conical mound 33 rising gradually at the top towards brewing assembly 2.

As will be clear from the above description, at each operating cycle, the free end of paddle 24 travels along an endless path A-B-A-C-D-E-A, one portion B-A-C-D of which extends inside bin 3, substantially along an arc of a circle centred about axis 7. So, when mound 33 rises to the point of interfering with portion B-A-C-D, the paddle levels mound 33 and distributes the waste material inside bin 3 to prevent mound 33 from reaching brewing assembly 2.

1. A brewing unit for brewed beverage-making machines, the unit comprising:
a brewing assembly; and
a bin located beneath the brewing assembly to catch waste material expelled from the brewing assembly;
wherein the brewing assembly includes a number of members, in turn comprising:
a brewing chamber for receiving brew material;
first unloading means movable along the brewing chamber to expel the waste material from the brewing chamber; and
second unloading means movable with respect to the brewing chamber to engage and unload the expelled waste material into the bin;
at least one of the number of members being an oscillating member designed to rotate about an axis;
wherein the brewing assembly further includes levelling means for levelling the waste material inside the bin; the levelling means being associated with the oscillating member to oscillate with it, and extending from the oscillating member into the bin.

2. The brewing unit as claimed in claim 1, wherein the levelling means comprise a paddle movable inside the bin.

3. The brewing unit as claimed in claim 2, wherein the paddle is comb-shaped.

4. The brewing unit as claimed in claim 1, wherein the brewing chamber is mounted to oscillate about the axis, and has a top opening movable about the axis along a path extending through a brew material loading position, a brewing position, and a waste material unloading position; the levelling means being mounted to oscillate with the brewing chamber about the axis.

5. The brewing unit as claimed in claim 4, wherein the second unloading means comprise a doctor located above the brewing chamber and substantially tangent to the path of the opening.

6. The brewing unit as claimed in claim 4, wherein the first unloading means comprise a piston movable by a reciprocating motion along the brewing chamber; the levelling means being integral with the piston to oscillate with the brewing chamber about the axis and translate with the piston with respect to the brewing chamber.

7. The brewing unit as claimed in claim 6, wherein the brewing chamber comprises a bottom wall, and the piston comprises a rod mounted to slide through the bottom wall and having a free end located outside the brewing chamber and facing the bin; the levelling means being connected integrally to the free end.

8. The brewing unit as claimed in claim 2, wherein the paddle slopes with respect to the rod towards a fall path along which the waste material engaged by the second unloading means drops.
